(19) United States
(12) Patent Application Publication
(10) Pub. No.: US 2018/0141170 A1
(43) Pub. Date: May 24, 2018

(54) RESTORATION OF CAST IRON USING IRON POWDER

(71) Applicant: Caterpillar Inc., Peoria, IL (US)

(72) Inventors: Tomasz J. CHOJNACKI, Peoria, IL (US); Kegan J. LUICK, Corinth, MS (US)

(73) Assignee: Caterpillar Inc., Peoria, IL (US)

(21) Appl. No.: 15/356,067

(22) Filed: Nov. 18, 2016

(51) Int. Cl. B23P 6/04; B23K 26/34; B23K 26/70; B23K 26/144; B33Y 10/00; B33Y 30/00; B33Y 40/00; B33Y 80/00

(52) U.S. Cl. CPC B23P 6/04; B23K 26/34; B23K 26/703; B23K 26/144; B23K 2203/02; B33Y 30/00; B33Y 40/00; B33Y 80/00; B33Y 10/00

(57) ABSTRACT

A method to restore a cast iron part is provided. The method includes providing the cast iron part with an impaired surface. The method further includes depositing a layer of repair material on the impaired surface of the cast iron part. The method further includes exposing the layer of repair material to heat to generate a cladding layer. The method further includes cooling the cladding layer.

### TECHNICAL FIELD

The present disclosure relates to a method and an apparatus for restoring a cast iron part using iron powder.

### BACKGROUND

Cast iron is typically a difficult material to repair using conventional welding procedures. The chemical composition and the heterogeneous microstructure of the cast iron lead to non-uniform heating with uneven wetting and thermal gradients. The non-uniform heating may produce cracks and defects that may render a cast iron part non-operational. This problem is typically overcome by using expensive nickel-based and self-fluxing alloys that allow better surface wetting and thermal strain tolerance. However, such nickel-based and self-fluxing materials can be cost-prohibitive to use on typical cast iron parts.

The research article “Microstructure Formation and Fracturing Characteristics of Grey Cast Iron Repaired Using Laser,” by Yi, P., et al. describes using iron-based alloy powders as the repair material for cast iron repair. Use of such iron-based alloy powders can be more expensive and requires additional steps, such as a preheating step to compensate for a difference in thermal expansion coefficients of cast iron and iron-based alloy.

### SUMMARY OF THE DISCLOSURE

In one aspect of the present disclosure, a method of restoring a cast iron part is provided. The method includes providing a cast iron part with an impaired surface. The method also includes depositing on the impaired surface layer of pure iron powder. The method further includes exposing the layer of pure iron powder to heat to generate an iron cladding layer and cooling the iron cladding layer.

In another aspect of the present disclosure, an apparatus to restore a cast iron part is provided. The apparatus includes a holding member configured to hold the cast iron part having an impaired surface. The apparatus also includes a depositing mechanism configured to deposit a layer of repair material of a predetermined thickness on the impaired surface. The apparatus further includes a laser system configured to generate a cladding layer by exposing the layer of repair material to a laser according to predetermined laser parameters. The apparatus also includes a cooling system configured to cool the cladding layer. The repair material and the cast iron part have substantially similar thermal expansion coefficients. The predetermined thickness of the layer of repair material, the predetermined laser parameters, and predetermined cooling parameters are selected to melt the repair material and to generate the cladding layer.

In yet another aspect of the present disclosure, a process to prepare a restored cast iron part is provided. The process includes providing a cast iron part with an impaired surface. The process also includes depositing on the impaired surface a layer of pure iron powder. The process further includes exposing the layer of pure iron powder to a laser to generate an iron cladding layer and cooling the iron cladding layer.

Other features and aspects of this disclosure will be apparent from the following description and the accompanying drawings.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a schematic sectional view of a non-restored cast iron part showing an impaired surface according to one or more embodiments of the present disclosure;

FIG. 2 is a schematic sectional view of a restored cast iron part according to one or more embodiments of the present disclosure;

FIG. 3 is a sectional view of a granular structure of a portion of the restored cast iron part of FIG. 2 according to one or more embodiments of the present disclosure;

FIG. 4 is a schematic sectional view of a restored cast iron part having a protrusion according to one or more embodiments of the present disclosure;

FIG. 5 is a schematic block diagram of an apparatus for restoring a cast iron part according to one or more embodiments of the present disclosure; and

FIG. 6 is a flow chart of a method of restoring a cast iron part according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Generally speaking, embodiments of the disclosed subject matter can involve an apparatus and a method for restoring a cast iron part having an impaired surface with defects, such as cracks, chips, and/or dents. The apparatus may include various operating modules, such as a preparing module for preparing the impaired surface of the cast iron part, a holding member for holding the cast iron part during a restoration process, a depositing mechanism for depositing a layer of repair material, such as pure iron powder, on the impaired surface, a heating module, such as a laser system, for heating the deposited layer of repair material and generating a cladding layer on the impaired surface, and a cooling system for cooling the cladding layer. Thus, the cast iron part with the impaired surface may be refurbished or salvaged to form a restored cast iron part ready to be returned to its application. As such, the useful life of the cast iron part may be increased.

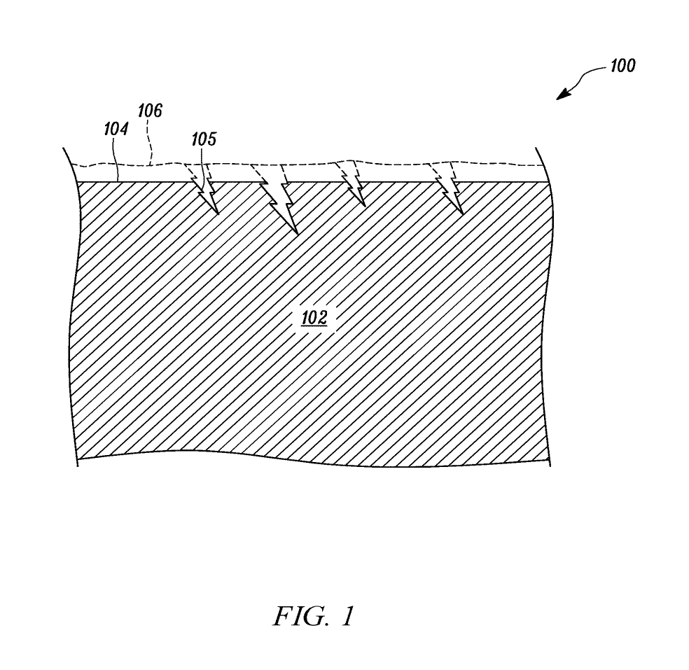

Referring to FIG. 1, a schematic sectional view of a non-restored cast iron part 100, according to one or more embodiments of the present disclosure, is illustrated. The non-restored cast iron part 100 may include a cast iron substrate 102 having an impaired surface 104. The impaired surface 104 may include defects 105, such as cracks, chips, and dents, formed in the cast iron substrate 102. In an example, the cracks, chips, and dents may encompass various defects, such as holes, cavities, scratches, crevices, interstices, fractures, rifts, and depressions. The defects 105 encompass any defect that exists substantially at or near the surface of the substrate and does not affect the structural integrity of the substrate as a whole.

In an embodiment, the cast iron substrate 102 may be a material of a machine component, otherwise referred to as the non-restored cast iron part 100, which may be used in various industries, such as construction, mining, agriculture and transportation. The machine component may be exposed to adverse ambient conditions such as high ambient temperature, and dust. The machine component may also be exposed to adverse operating conditions such as high load acting on the machine component. More specifically, one or more surfaces of the machine component may be exposed to one or both of the adverse ambient conditions and the adverse operating conditions. Over a period of time, undesired defects, such as the cracks, chips, and dents may be formed on the one or more surfaces, otherwise referred to as an original surface 106, of the machine component.

In one embodiment, the cast iron substrate 102 may include an alloy of iron and carbon such as graphite. In some embodiments, the cast iron substrate 102 may include silicon and may have additional elements, such as manganese, nickel, copper, magnesium, sulfur, phosphorus, chromium, bismuth, tellurium, and/or molybdenum, either alone, or in combination. In the present embodiment, the non-restored cast iron part 100 may be, but not limited to, grey cast iron, white cast iron, compacted graphite, ductile cast iron, and malleable cast iron. The impaired surface 104 may include the cracks, chips, and/or dents with a depth of 0.1 mm or greater. Accordingly, in the present embodiment, the depth of the chips, cracks, and/or dents formed on the impaired surface 104 may be between 0.1 millimeter (mm) and 10 mm. However, the depth of the defects to be repaired is dependent upon the application of the cast iron part 100. That is, the depth of the defects to be repaired is a depth at which such defects in the cast iron part 100 render the part non-operational for its corresponding application.

In an embodiment, the impaired surface 104 of the cast iron substrate 102 may be prepared by a machining process for repairing the non-restored cast iron part 100. The original surface 106 having the defects 105 may undergo the machining process for preparing the impaired surface 104. The machining process may include removal of a layer of material from the original surface 106 of the non-restored cast iron part 100 to form the impaired surface 104. In an example, the machining process may include grinding of the original surface 106 to remove the layer of material. Thus a ground surface may be formed on the substrate 102. The machining process may also include polishing the ground surface and cleaning the polished surface to form the impaired surface 104.

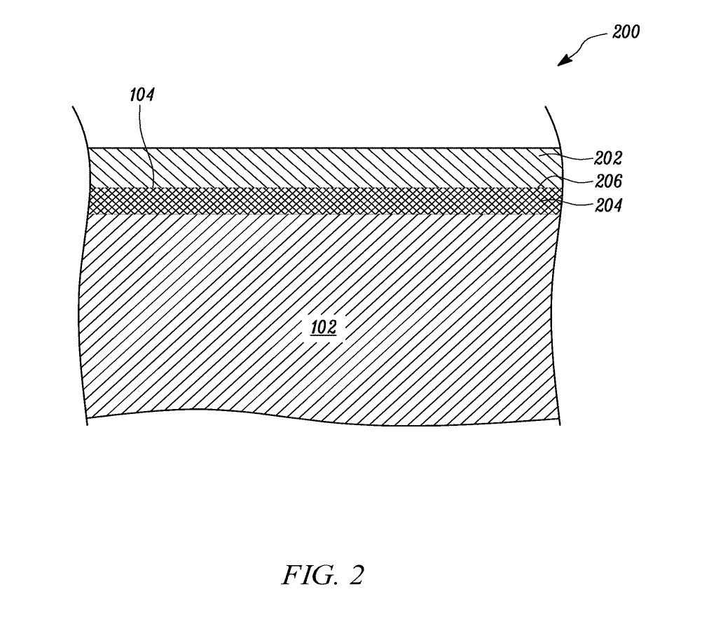

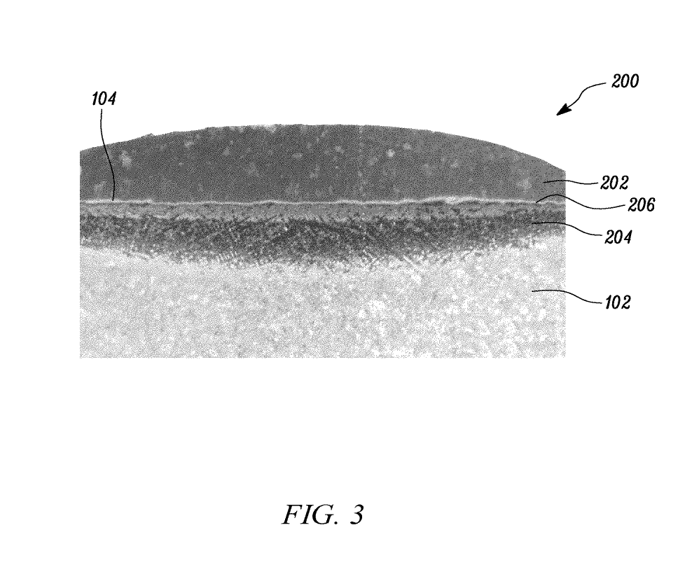

Referring to FIG. 2, a restored cast iron part 200, according to one or more embodiments of the present disclosure, is illustrated. Referring to FIG. 3, a sectional view of a granular structure of a portion of the restored cast iron part 200, according to one or more embodiments of the present disclosure, is illustrated. Referring to FIG. 2 and FIG. 3, the restored cast iron part 200 includes the cast iron substrate 102. The restored cast iron part 200 further includes a cladding layer 202 disposed on the impaired surface 104 defined on the cast iron substrate 102. The cladding layer 202 may have a predetermined thickness defined from the impaired surface 104 of the cast iron substrate 102. The cladding layer 202 is formed from a repair material. In one embodiment, the repair material may be a pure iron powder. In another embodiment, the repair material may be a powder including iron and other materials. The cladding layer 202 covers the cracks, chips and/or dents formed on the impaired surface 104 of the cast iron substrate 102. The restored cast iron part 200 may further include a heat affected zone 204, which is formed below the impaired surface 104 of the cast iron substrate 102 for a predefined thickness. The heat affected zone 204 may be formed during formation of the cladding layer 202 on the impaired surface 104 of the cast iron substrate 102. An interface 206 is formed between the cast iron substrate 102 and the cladding layer 202. In an embodiment, the interface 206 may include graphite particles. In one example, the interface 206 may be defined as a surface of contact between the impaired surface 104 of the cast iron substrate 102 and the cladding layer 202.

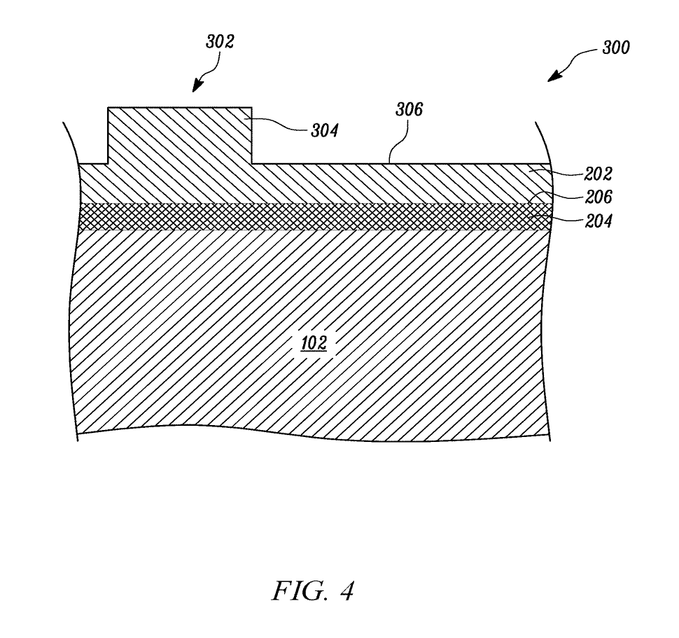

Referring to FIG. 4, a schematic sectional view of a restored cast iron part 300, according to one or more embodiments of the present disclosure, is illustrated. The restored cast iron part 300 may include the cast iron substrate 102, the cladding layer 202, the heat affected zone 204, and the interface 206 as described above with reference to the restored cast iron part 200 of FIG. 2. The restored cast iron part 300 may further include a protrusion 302 formed by a supplementary cladding layer 304 on a surface 306 of the cladding layer 202. In one embodiment, the supplementary cladding layer 304 may be formed by depositing one or more additional layers of the repair material on the surface 306 of the cladding layer 202. That is, the supplementary cladding layer 304 may be formed by iteratively forming multiple cladding layers on top of each other. In this embodiment, to form each of the multiple cladding layers, the repair material is deposited on the surface 306 of the cladding layer 202 or on the surface of a previously formed supplementary cladding layer. The deposited repair material is then formed into a cladding layer by heat exposure and subsequently cooled. In this embodiment, the processes of depositing the repair material, forming a cladding layer by heat exposure, and cooling are repeated for each additional cladding layer included in the protrusion 302. In some embodiments, multiple protrusions 302 may be formed on the cladding layer 202. In certain embodiments, any suitable shape may be defined on the cladding layer 202 by forming multiple cladding layers of repair material on the surface 306 of the cladding layer 202.

The embodiment shown in FIG. 4 may be used to dimensionally restore or modify the cast iron part 100. That is, a protrusion of the iron part 100 that was ground down by operational load may be restored by the embodiment of FIG. 4 by forming the protrusion 302 using the supplemental cladding layer 304. Alternatively, the cast iron part 100 may be modified for improved or different use by adding the protrusion 302 during restoration of the impaired surface 104.

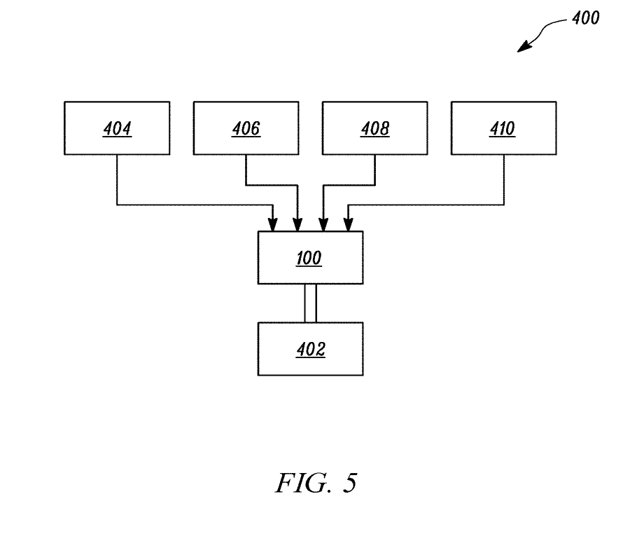

Referring to FIG. 5, an apparatus 400 for restoring the cast iron part 100 having the impaired surface 104, according to one or more embodiments of the present disclosure, is illustrated. The apparatus 400 may include a holding member 402 that may be used to hold the cast iron part 100 during a restoration process. In one embodiment, the holding member 402 may be a jig, a fixture, or an industrial pallet for holding the cast iron part 100. In some embodiments, the holding member 402 may be any suitable mechanical device used for fixedly holding the cast iron part 100 on a work surface (not shown) during the restoration process. The cast iron part 100 may be held by the holding member 402 in such a way that the impaired surface 104 of the cast iron part 102 may be positioned in an upward orientation.

The apparatus 400 may also include a preparing module 404 configured to prepare the impaired surface 104 for repairing the cast iron part 100. In one embodiment, the preparing module 404 may be configured to prepare the impaired surface 104 before the cast iron part 100 is mounted on the holding member 402. As such, the impaired surface 104 of the cast iron part 100 may be prepared separately using a machining process and then the cast iron part 100 having the impaired surface 104 may be held in position using the holding member 402 for restoring the cast iron part 100. In another embodiment, the preparing module 404 may be configured to prepare the impaired surface 104 of the cast iron part 100 after the cast iron part 100 is mounted on the holding member 402. As such, the impaired surface 104 of the cast iron part 100 may be prepared using the machining process during the restoration process of the cast iron part 100.

In an embodiment, the preparing module 404 may include a grinding head configured to grind and/or remove a layer of material from the original surface 106 of the non-restored cast iron part 100 to form the impaired surface 104. Thus, a ground surface may be formed on the cast iron part 100. The preparing module 404 may further include a polishing head configured to polish the ground surface and hence to provide a polished surface on the cast iron part 100. The preparing module 404 may further include a cleaning head configured to clean the polished surface by spreading a fluid on the polished surface to provide a clean surface. In other embodiments, the preparing module 404 may include various other machine tools or machining centers to prepare the cast iron part 100 for restoration, without limiting the scope of the present disclosure.

The apparatus 400 may further include a depositing mechanism 406 configured to deposit a layer of repair material on the impaired surface 104 of the cast iron part 100. The repair material may include pure iron or pure iron powder. The impaired surface 104 may have a temperature between 10° C. and 40° C. during the depositing of the repair material. That is, the impaired surface 104, as well as the cast iron part 100 as a whole, may be at ambient temperature during deposition of the repair material. This is because the respective thermal coefficients of the cast iron part 100 and the pure iron repair material are similar enough, such that a pre-heating step prior to depositing the repair material is not required.

In some embodiments, the repair material may include powder, particles, granules, dust and/or substance of pure iron. In an example, the repair material may be a commercially available iron powder ABC100.30 provided by North American Hoganas, or may be one of other commercially available iron powders. In some embodiments, the depositing mechanism 406 can be used to deposit any type of repair material on the impaired surface 104 of the cast iron part 100. In various examples, the depositing mechanism 406 may be a machine operated based on a manual input or a mechanical input to deposit a desired amount of the repair material on the impaired surface 104 of the cast iron part 100. In the present embodiment, the depositing mechanism 404 may be configured to deposit the layer of repair material based on various parameters including, but not limited to, a thickness and a density of the layer of repair material. The thickness of the layer of repair material can be between 1 mm and 100 mm. The density of the repair material, such as the iron powder, can be between 1 g/cm³ and 10 g/cm³.

The apparatus 400 may further include a heating module, such as a laser system 408, configured to generate the cladding layer 202 by exposing the layer of repair material to a laser. In an embodiment, the layer of repair material may be exposed to the laser having predetermined laser parameters including, but not limited to, a predetermined laser radius, a laser wavelength, and a laser power. In an example, the predetermined laser radius may be between 1 mm and 5 mm, the laser wavelength may be between 0.800 micrometer (μm) and 1.2 μm, and the laser power may be between 500 watts (W) and 8 kilowatts (kW).

For example, the laser system 408 may include any laser technology that can apply energy in an 800 nm-1200 nm wavelength range,

Further, the impaired surface 104 may be maintained at ambient temperature during depositing of the layer of repair material and at start of exposure of the layer of repair material to the laser. This is because, as described above, the thermal expansion coefficients of the repair material and the cast iron part 100 are similar enough to obviate the need for a pre-heating step prior to depositing the repair material. As such, the step of depositing the repair material may be performed at ambient temperature and, therefore, at the start of the exposure to the laser, the cast iron part 100 having the repair material deposited thereon may also be at ambient temperature.

In the present embodiment, the laser system 408 may be configured to form the heat affected zone 204 below the impaired surface 104 of the cast iron part 100. In some embodiments, the heat affected zone 204 may also be formed in the layer of repair material. The heat affected zone 204 can be formed by application of heat from the laser to the cast iron part 100 having the layer of repair material. In some embodiments, the heat may be applied on the layer of repair material by the laser system 408 directly or indirectly.

In various embodiments, the heating module, such as an electric system, an induction heating system or any other suitable thermal system, may be used for applying heat to the layer of repair material. In one embodiment, the laser system 408 may include an Nd:YAG (Neodymium-doped Yttrium Aluminium Garnet) as a lasing medium. In other embodiments, the laser system 408 may include any suitable lasing medium for applying desired heat on the layer of repair material. For example, the laser system 408 may include any laser technology that can apply energy in an 800 nm-1200 nm wavelength range, including diode lasers or fiber lasers. In one embodiment, the Nd:YAG laser can have a radius between 1 mm and 5 mm and a laser power between 2 kW and 5 kW. The laser may sweep/scan over the layer of repair material through displacement of the cast iron part 100 or through displacement of the laser. In an embodiment, the displacement of the cast iron part 100 or the displacement of the laser may have a predetermined scanning speed and a predetermined scanning direction. In an example, the predetermined scanning speed can be between 1 mm/s and 1000 mm/s, and the predetermined scanning direction may be longitudinal.

The interface 206 can be formed in the heat affected zone 204 between the impaired surface 104 and the layer of repair material. The interface 206 can be substantially free of cracks, chips and dents. The interface 206 can also include graphite particles. The exposure of the layer of repair material to heat generates the cladding layer 202 on the impaired surface 104 of the cast iron part 100. Thus, the cladding layer 202 is disposed on the interface 206. The cladding layer 202 forms a protective layer on the cast iron part 100 by covering the cracks on the impaired surface 104. The cladding layer 202 is substantially without cracks and/or chips. The cladding layer 202 can be an iron cladding layer. The cladding layer 202 can include a quantity of carbon that migrates across the interface 206 from the cast iron part 100. The quantity of carbon may be less than 5.0% by weight of the cladding layer 202. The repair material parameters, the laser parameters and the scanning parameters can be predetermined to melt the repair material and to provide the cladding layer 202 without cracks on the impaired surface 104.

The apparatus 400 may further include a cooling system 410 configured to cool the cladding layer 202 generated by the laser system 408. The cladding layer 202 can be cooled using the cooling system 410 to complete the restoration process of the cast iron part 100. In an embodiment, the cooling system 410 can include predetermined cooling parameters including, but not limited to, a medium for cooling the cladding layer 202 and a rate at which temperature of the cladding layer 202 is to be decreased. The cooling parameters may also be selected to provide the cladding layer 202 without cracks. In various embodiments, the cooling of the cladding layer 202 can be done using available cooling techniques. In some embodiments, the cooling can be done by exposing the cladding layer 202 to air so as to bring the cladding layer 202 to the ambient temperature.

The apparatus 400 may also be configured to form the restored cast iron part 300 according to an embodiment of the present disclosure. Specifically, the apparatus 400 may be configured to form the protrusion 302 by forming one or more cladding layers by depositing one or more layers of repair material on the surface 306 of the cladding layer 202 of the restored cast iron part 200. The depositing mechanism 406, the laser system 408, and the cooling system 410 may be configured to repeatedly process the restored cast iron part 200 to form the supplementary cladding layer 304. The depositing mechanism 406 may deposit the one or more layers of repair material based on various parameters including, but not limited to, a desired thickness of the protrusion 302. In an embodiment, forming the protrusion 302 on the cladding layer 202 may complete the restoration process of the cast iron part 100 to form the restored cast iron part 300.

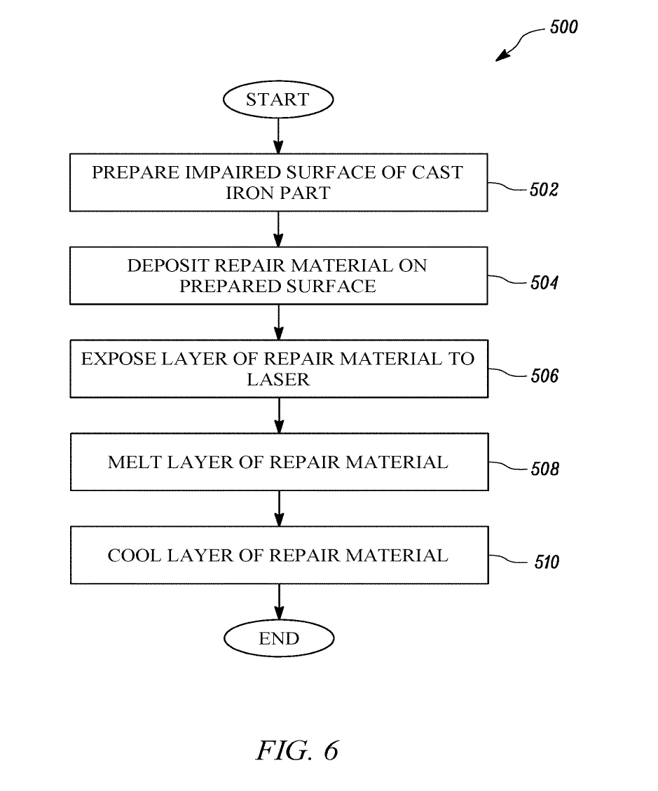

Referring to FIG. 6, a flowchart of the method 500 of restoring the cast iron part 100 is illustrated according to one or more embodiments of the present disclosure. At step 502, the method 500 includes preparing the impaired surface 104 of the cast iron part 100 for repair. The impaired surface 104 may be prepared by the preparing module 404 by removing a layer of material from the cast iron part 100. In an embodiment, preparing the impaired surface 104 of the cast iron part 100 may include grinding the original surface 106 of the non-restored cast iron part 100, polishing the ground surface by a polishing head, and cleaning the polished surface by a cleaning head. In other embodiments, other preparatory steps may be taken in addition to or instead of the grinding, polishing, and cleaning. Generally step 502 encompasses processing of the surface of the cast iron part 100 in preparation for depositing the repair material.

At step 504, the method 500 includes depositing a layer of repair material on the prepared surface of the cast iron part 100. In an embodiment, the repair material is deposited on the impaired surface 104 of the cast iron part. In an embodiment, the layer of repair material is a layer of pure iron powder. The layer of pure iron powder may be deposited on the impaired surface 104 by the depositing mechanism 406. The layer of pure iron powder may be deposited on the impaired surface 104 in a predetermined thickness. The predetermined thickness of the layer of pure iron powder may be based on a thickness of material removed from the original surface 106 of the non-restored cast iron part 100 to form the impaired surface 104 in step 502. In an embodiment, the predetermined thickness of the layer of pure iron powder may be based on a desired thickness of the cladding layer 202. The cast iron part 100 may have a temperature between 10° C. and 40° C., or ambient temperature, during the depositing of the layer of pure iron powder on the impaired surface 104.

At step 506, the method 500 may include exposing the layer of repair material, such as the pure iron powder to a laser of the laser system 408. The method 500 may further include sweeping/scanning the laser over the layer of pure iron powder through displacement of the cast iron part 100 or through displacement of the laser based on a predetermined scanning speed and a predetermined scanning direction. At step 508, the method 500 may include exposing the layer of pure iron powder to the laser and melting the layer of pure iron powder. As such, the layer of pure iron powder may be brought to a predefined temperature. Thus, an iron cladding layer, otherwise the cladding layer 202, may be generated on the impaired surface 104 of the cast iron part 100. The iron cladding layer may include carbon that may migrate from the cast iron part 100. The quantity of the carbon may correspond to less than 5.0% by volume of carbon. At step 510, the method 500 may include cooling the layer of pure iron powder by the cooling system 410. Cooling of the layer of pure iron powder may be performed based on cooling parameters. Thus the method 500 of the present disclosure may be implemented to restore or repair the cast iron part 100 having the impaired surface 104 to from the restored cast iron part 200.

Although the steps of the method 500 of the present disclosure are illustrated in a sequence as above, it may be understood that each of the above steps may be applied or implemented in other operable sequences without deviating from the scope of the present disclosure. Further, the method 500 may include additional steps apart from the above steps to restore the cast iron part 100.

In an embodiment, the method 500 may further include forming the protrusion 302 by repeating the steps of method 500 to form one or more cladding layers on top of the cladding layer 202. In this embodiment, each of the repetitions may include deposition of the layer of pure iron powder on the cladding layer 202 or on a previously formed supplementary cladding layer by the depositing mechanism 406. The method 500 may further include exposing the deposited layer of pure iron powder to the laser by the laser system 408. The deposited layer of pure iron powder may be melted by the heat of the laser to generate the supplementary layer 304. The method 500 may further include cooling the melted supplementary layer on top of the cladding layer 202 or on top of a previously formed supplementary cladding layer to form the protrusion 302.

### INDUSTRIAL APPLICABILITY

The present disclosure relates to a method 500 and an apparatus 400 for restoring the cast iron part 100. The apparatus 400 of the present disclosure performs the restoration process on a cracked or otherwise impaired surface 104 of the cast iron part 100 such that a life of the machine component having the cast iron part 100 is increased. As such, cost associated with the replacement of the cast iron part 100 or with the replacement of the machine component having the cast iron part 100 may be eliminated.

According to the present disclosure, surface morphology and usability of the cast iron part 100 can be restored by generating the cladding layer 202 that is substantially free of cracks, chips or dents. A predetermined thickness of the cladding layer 202 may be defined to sufficiently cover the defects in the impaired surface 104 of the cast iron part 100. The method 500 and the apparatus 400 can be used on different types of cast iron, such as the grey cast iron, white cast iron, compacted graphite, ductile cast iron, and malleable cast iron. Preheating the cast iron part 100 during the restoration process can be eliminated because the thermal expansion coefficients of the cast iron part 100 and the pure iron powder as the repair material are substantially similar. The method 500 can modify the impaired surface 104 of the cast iron part 100 by generating several cladding layers on top of each other. The cladding layer 202 may contain a small amount of carbon, for example, less than 2.0% by volume of carbon, which may provide desired strength and durability to the cast iron part 100. Further, the method 500 can offer a significant cost reduction over conventional apparatus and methods for repairing cast iron, which rely on expensive nickel-based and self-fluxing alloys. Also, the method 500 can provide better surface wetting and thermal strain tolerance than the conventional techniques for repairing cast iron.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of restoring a cast iron part comprising:
providing a cast iron part with an impaired surface;
depositing on the impaired surface a layer of pure iron powder;
exposing the layer of pure iron powder to heat to generate an iron cladding layer; and
cooling the iron cladding layer.

2. The method of claim 1, wherein the impaired surface includes cracks or chips.

3. The method of claim 2, wherein the impaired surface includes chips having a depth between 0.1 mm and 10 mm.

4. The method of claim 1, wherein the impaired surface has a temperature between 10° C. and 40° C. during the depositing and at the start of the exposing.

5. The method of claim 1, wherein the iron cladding layer contains carbon that migrates from the cast iron part.

6. The method of claim 5, wherein the quantity of the carbon corresponds to less than 5.0% by volume of carbon.

7. The method of claim 1, wherein the cast iron part contains at least one of grey cast iron, white cast iron, compacted graphite, and ductile cast iron.

8. The method of claim 1, further comprising forming a protrusion by repeating the depositing, the exposing, and the cooling to form supplementary layers on top of the cladding layer.

9. The method of claim 1, wherein an interface between the cast iron part and the generated iron cladding layer includes graphite particles.

10. An apparatus to restore a cast iron part comprising:
a holding member configured to hold the cast iron part, the cast iron part having an impaired surface;
a depositing mechanism configured to deposit a layer of repair material of a predetermined thickness on the impaired surface;
a laser system configured to generate a cladding layer by exposing the layer of repair material to a laser according to predetermined laser parameters; and
a cooling system configured to cool the cladding layer,
wherein the repair material and the cast iron part have substantially the same thermal expansion coefficients, and
the predetermined thickness of the layer of repair material, the predetermined laser parameters, and predetermined cooling parameters are selected to melt the repair material during the exposure of the layer of repair material to the laser and to generate the cladding layer.

11. The apparatus of claim 10, wherein the predetermined thickness of the layer of repair material is between 1 mm and 100 mm and the predetermined laser parameters include an Nd:YAG laser having a radius between 1 mm and 5 mm and a laser power between 2 kW and 5 kW.

12. The apparatus of claim 10, wherein the repair material is pure iron powder.

13. The apparatus of claim 10, wherein the repair material is pure iron.

14. The apparatus of claim 10, wherein the impaired surface has a temperature between 10° C. and 40° C. during the depositing and at the start of the exposing.

15. The apparatus of claim 10, wherein the cladding layer contains carbon that migrates from the cast iron part.

16. The apparatus of claim 15, wherein the quantity of the carbon corresponds to less than 5.0% by volume of carbon.

17. The apparatus of claim 10, wherein the cast iron part contains at least one of grey cast iron, white cast iron, compacted graphite, and ductile cast iron.

18. The apparatus of claim 10, wherein the apparatus is configured to form a protrusion by repeatedly depositing the layer of repair material by the depositing mechanism, generating a supplementary cladding layer by the laser system, and cooling the supplementary cladding layer by the cooling system.

19. The apparatus of claim 10, wherein an interface between the cast iron part and the generated cladding layer comprises graphite particles.

20. A restored cast iron part prepared by a process comprising:
providing a cast iron part with an impaired surface;
depositing on the impaired surface a layer of pure iron powder;
exposing the layer of pure iron powder to a laser to generate an iron cladding layer; and
cooling the iron cladding layer.
